(19) United States
(12) Patent Application Publication
(10) Pub. No.: US 2026/0126404 A1
(43) Pub. Date: May 7, 2026

(54) METHOD FOR TREATING BULK MATERIAL COMPOSED OF PREDOMINANTLY METALLIC OBJECTS AND DEVICE FOR IMPLEMENTING SUCH A METHOD

(71) Applicant: RECOVER PURE MATERIALS GmbH, Pforzheim (DE)

(72) Inventor: Georg Schons, Eigeltingen (DE)

(73) Assignee: RECOVER PURE MATERIALS GmbH, Pforzheim (DE)

(21) Appl. No.: 19/118,597

(22) PCT Filed: Jun. 19, 2023
(86) PCT No.: PCT/EP2023/066424

§ 371 Date: Apr. 4, 2025

(30) Foreign Application Priority Data
Oct. 5, 2022 (DE) 10 2022 125 632.4

(51) Int. Cl. G01N 23/223; B07C 5/34; G01N 21/71

(52) U.S. Cl. CPC G01N 23/223; B07C 5/34; G01N 21/718

(57) ABSTRACT

The invention relates to a method for treating bulk material made of predominantly metal objects, having the steps of carrying out a process of individualizing objects in a supply step (S3), wherein the individualizing process leads to a substantially one-dimensional arrangement of individual parts one behind the other with a minimum spacing between one another that corresponds to the time interval required by an analysis system to analyze an object for a given supply speed; carrying out an X-ray fluorescence analysis (XRF analysis) or a laser-induced breakdown spectroscopy (LIBS) of individual objects provided in the supply step by means of an analysis system in an analysis step (S4); ascertaining the material composition of the individual objects of the analysis step in an evaluation step (S5); and carrying out a subsequent treatment step (87) in which the ascertained material composition of the individual objects is used as the basis for the subsequent treatment.

### BACKGROUND OF THE INVENTION

The present invention relates to a method for treating bulk material composed of predominantly metallic objects and a device for implementing a method for treating bulk material composed of predominantly metallic objects.

In recent years and decades, the reuse of raw materials or the return of raw materials into a production or product life cycle, often summarized under the keyword “recycling”, has become increasingly important in the raw materials industry. Due to the currently high and still increasing consumption of resources, it is essential for future resource management that as many raw materials as possible can be used for multiple product life cycles, which is why a high degree of recycling is inevitably necessary.

In the field of treatment and reuse of metals, there have been various approaches and methods for separating metals from non-metals, for separating non-ferrous metals from ferrous metals, and for separating precious metals from base metals, for example.

However, these methods still have various disadvantages. For example, one disadvantage is that the process from the reclamation of an object to the generation or production of renewed or processed raw materials, which in turn can be fed into a production process, requires many individual steps and individual processes, which today are carried out by a plurality of different economic units. As a rule, the more further processing or treatment that is carried out, the higher the value or the concentration of the recoverable components. At the beginning, the recoverability, for example of bulk metal or a bulk material composed predominantly of metallic parts, is not only low but also largely undetermined. It is therefore not readily apparent whether a source material, for example a bulk material, composed predominantly of metallic objects has an infinitesimally small amount of recoverable components or objects, which basically makes an economic reclamation, in particular an economic concentration of the recoverable components, impossible, or whether, in contrast, the initial concentration, while being low, is high or great enough for an economic reclamation and also a recovery of the recoverable components after suitable pre-treatment or concentration processes to make economic sense.

The cost of treatment for recovering the individual raw materials from a source mixture, e.g., a bulk material with mainly metallic objects, is another problem which is also indirectly related to the source material and the concentration of recoverable components in the source material. In principle, many different methods are known. However, two factors are interrelated: the preliminary processes and the related costs for the acquisition and operation of such plants on the one hand, and the prices of raw materials and the potential profits from the recovered raw materials on the other hand. In the case of metals, if the work and the costs for treatment and separation were negligible, the optimal case would be to first produce metal fractions that are absolutely pure in terms of type, and then to melt and/or clean them in order to obtain raw materials or resources that can be fed into a manufacturing process. In reality, however, the methods and devices used to produce material fractions with concentrated contents of valuable or recoverable objects from a source mixture, in particular a source bulk material, are anything but negligible. This means that, even with rising raw material prices, the concentration of recoverable objects or the production of fractions with a correspondingly high content of recoverable objects or components has to be carried out as effectively and cost-efficiently as possible; furthermore, the effort involved, in particular with regard to costs, must be such that the proceeds ultimately achievable from the sale of resources or precursors of resources, such as precious metals, does not turn out to be less than the previously invested effort for sorting or concentrating.

With this in mind, the prior art has typically been employing methods and devices that cause as little effort as possible, can be operated cost-effectively and also allow a high throughput of material or mass, even if only a low concentration or yield is achieved with these methods.

A method for sorting scrap metal, in particular scrap aluminum, is known from WO 2017/194585 A1. It proposes analyzing spaced-apart individual parts by means of XRF or LIBS in order to determine the contents of Mg, Mn, Si or Fe in a surface layer. Mg and Si, in particular, cannot be identified/measured by XRF.

US 2022/0016675 A1 additionally teaches a multi-stage sorting system also featuring an analysis by means of XRF or LIBS in addition to an optical analysis and distance measurement.

### SUMMARY OF THE INVENTION

Accordingly, the object of the present invention is to propose methods and devices that overcome the problems existing in the prior art, in particular methods and devices that are able to determine the current or original content of recoverable objects, in particular metals, in a bulk material predominantly composed of metallic objects in a reliable and accurate manner and with reasonable effort and/or to achieve a highly effective concentration of largely pure fractions of metals, in particular copper and/or precious metals, without the costs or investments for producing the fractions outweighing the advantages of further use or further treatment of the fractions.

This object is attained by a method having the features disclosed herein. Furthermore, this object is attained by a device having the features disclosed herein.

Advantageous embodiments of the invention are the subject of the following description, the figures, the figure description and the dependent claims. In principle, features disclosed in connection with the method shall also be considered as features disclosed in connection with the device and vice versa.

The method according to the invention is based on the idea that each individual object, in particular each individual metal object of the bulk material, is analyzed individually. This represents a departure from known methods in that the throughput is inevitably limited, not least by the analysis speed or the analysis frequency of the analyzing system. Nevertheless, it has turned out in an unexpected manner that, depending on the field of application or in the interaction with correspondingly advantageous boundary conditions, this method, in which each individual object, in particular each individual metal object, is analyzed and the results of the analysis are used as the basis for further processing or further treatment, surprisingly offers the possibility of generating such an amount of added value at a justifiable amount of effort and at justifiable costs that this added value for the further treatment of the bulk material outweighs the effort or the costs despite the comparatively high effort involved in both the implementation of the method and with regard to the investment in equipment technology.

The reason for this lies in particular in the fact that, on the one hand, the individualization of the objects and the individual analysis of the objects requires a great deal of effort and thus reduces and limits the throughput per unit of time accordingly; on the other hand, however, the individualization, once carried out, and the knowledge about the composition, in particular the alloying of the individual objects, can be used particularly advantageously in the follow-up to the analysis in order to enable an effective and efficient further treatment of the bulk material.

In other words, this means that the invention has unexpectedly recognized that the effort for individualization and individual analysis of the objects, which is intuitively considered to be far too high, surprisingly results in particular advantages in the follow-up to the analysis with regard to further processing or further treatment and is thus justified overall or is more advantageous than a less precise analysis which analyzes more parts or a larger mass of parts in a shorter time but cannot be used as effectively and advantageously for further treatment in the follow-up to the analysis result.

Basically any bulk material that is composed of predominantly metallic objects and that is to be expected to contain a suitable proportion of recoverable objects, in particular precious metals, due to its origin can be used as the bulk material treated with the present method. Such source materials include, for example, bulk material from the reclamation of vehicles or motor vehicles, bulk material composed of residues from thermal reclamation of waste, bulk material composed of predominantly metallic objects from the dental industry, in particular from dental practices, or bulk material from the reclamation of crematorium ashes, and many other types of bulk materials composed of predominantly metallic objects.

When carrying out the individualization in a feeding step, the one-dimensional single-file arrangement should be understood to mean that individual objects are essentially arranged one behind the other. In particular, a distribution of multiple objects in a width direction-perpendicular to the feeding direction-with multiple objects at the same height in the feeding direction should be avoided. Similarly, an accumulation of multiple objects on top of each other-perpendicular to the feeding direction and perpendicular to the width direction-should be prevented. A certain deviation or offset of the individual objects in the width direction can be tolerated. In other words, this means that the one-dimensional single-file arrangement does not necessarily require such an exact alignment of the objects that the objects themselves or their centers of gravity are arranged in a perfectly straight line one behind the other, but rather that the objects are individualized in such a manner that when they reach the analyzing system, only one individual object at a time enters the analyzing area of the analyzing system and is analyzed there.

Accordingly, the distance in the feeding direction or the minimum distance in the feeding direction as a result of the individualization is chosen in such a manner that, at a given feeding speed, the minimum distance in the feeding direction is chosen in such a manner that each individual part or each individual object can be analyzed by the analyzing system. By manner of example and without limitation, this means that if an analyzing system can perform or carry out ten analyses per second and the feeding step has a feeding speed of 0.5 meters per second, the individualization must be designed or carried out in such a manner that a minimum distance of at least 0.05 meters or 5 centimeters must be maintained between adjacent objects in the feeding direction.

In the further treatment step according to the invention, as already mentioned above, the material composition of the individual object determined in the evaluating step is made the basis of the further treatment. This means that a further treatment of the individual objects can be carried out in an inventive manner that is relatively slow but highly precise and correspondingly effective, which in turn enables highly precise and correspondingly effective treatment or further treatment of the bulk material overall or by extrapolation.

According to the invention, it is provided that in the course of the X-ray fluorescence analysis (XRF analysis) or the laser-induced plasma spectroscopy (LIPS) by means of an analyzing system, the individual parts are analyzed from two essentially opposite, preferably parallel, analyzing directions so that each individual part is analyzed from two sides. It has been found that for parts that do not have a homogeneous material distribution, the results of the analyzing step are significantly better and more meaningful than in the case of an analysis from just one direction. In a particularly advantageous manner, an inspection or an analysis from two essentially opposite, preferably parallel, directions can be used to specifically address inhomogeneities in the parts and to determine the material composition very well and reliably overall. For example, in the case of electrical contacts or contact pins or contact pads, a precious-metal content can only be recognized from one side or on one main surface.

An opposite, two-sided analysis can be made possible, for example, by transferring the parts to a drop section on which the parts are in free fall. In this state, it is particularly easy to measure or analyze from different, in particular opposite directions. If necessary, different falling behavior of the parts, essentially due to different air resistances, is to be taken into account, so that it is ensured that the adjacent parts do not go below the necessary minimum distance even during free fall. In order to ensure this, a distance between the individual parts that is correspondingly greater than the minimum distance can first be established or set in the preceding individualizing step in order to then ensure that the distance does not go below the minimum distance during free fall until the analysis. The analysis can be carried out simultaneously or in succession from the different sides or directions along the fall section.

Alternatively, following the individualization of the individual parts, the individual parts can be transported during or while passing through the analyzing system by means of a transport device that is transparent or at least largely transparent for the analysis method or the analysis radiation. This enables a two-sided analysis of the individual parts from essentially opposite directions.

Alternatively, a first analysis can be carried out from a first direction, and the individual parts are then turned in a constrained manner, preferably by 180°, and analyzed again after turning. This allows the direction of analysis to remain unchanged with respect to the transport of the individual parts and still allows an analysis from two essentially opposite directions. Advantageously, the individual parts can be guided in such a manner that the same analyzing system is used after turning as for the analysis prior to turning. However, to enable a higher throughput of parts, a separate, preferably downstream, analyzing system can be used to accomplish the analysis of the individual parts from an essentially opposite direction. For example, a so-called turning wheel can be used to turn the individual parts.

The production of one or more essentially one-dimensional single-file arrangements of individual parts can also comprise an inspection step in which the distance between the individual parts is measured again and individual parts are ejected, preferably blown out, if the minimum distance is not met or not maintained. This preferably takes place prior to the analyzing step. For example, an optical inspection of the distance can be carried out with a camera system in the visible spectrum. However, other distance inspection devices can also be used. The ejection can be carried out by a compressed air nozzle or a mechanical pusher, for example. However, other discharge units can also be used. The ejected individual parts are preferably reintroduced into the input material stream, for example after a presorting step, in order to be analyzed after all.

As already indicated above, the reduced throughput due to the analysis of each object of a bulk material composed of predominantly metallic objects is a bottleneck of the throughput for the entire method. Hence, it can be particularly advantageous if, first of all or in general, the bulk material is presorted, the presorted material then being fed to and analyzed by the method. In the presorting step, a dedusting, i.e., a sorting out of particles with a size of up to 4 mm in at least one spatial direction, can take place, for example. This also facilitates the subsequent analysis since no micro-and dust particles affect or falsify the result of the analysis; instead, only one individual object alone and taken in isolation is analyzed exclusively.

Alternatively or in addition to presorting, it may also be provided that in the course of individualization of the objects, not only a single-file arrangement of objects with an appropriate minimum distance is produced, but a plurality of such single-file arrangements are generated, which preferably run or are aligned parallel to one another, each arrangement of objects maintaining said minimum distance of the individual objects. This can be made possible by combining switch points/splitters and individualization devices, for example. This is a particularly advantageous manner of multiplying the throughput of the method.

In this context, it can be particularly advantageous to provide for the analyzing system to have a plurality of measuring probes, each of which is assigned to a single-file arrangement of objects and each of which analyzes the individual objects in the course of the determination of the material composition. In a particularly advantageous manner, especially when using an excitation or radiation source of an analyzing system, a single or common excitation or radiation source can be used, and the reaction or interaction with the objects can be detected and/or forwarded via the measuring probe in question. The aforementioned variations particularly advantageously increase the throughput of the method many times over without causing considerable additional complexity of the system and method technology.

According to an advantageous embodiment, the method according to the invention may provide for a presorting step to be carried out prior to the analyzing step, in particular prior to the individualization of the objects; in said presorting step, part of the bulk material is sorted out and not fed to the analyzing system. A presorting step may be useful especially if or whenever the method according to the invention is not used with the aim of also obtaining as precise a knowledge as possible of the overall composition or the average composition of the bulk material in the further treatment step, but the further treatment step is to involve concentrating or sorting out recoverable objects, in particular objects containing precious metal and/or objects containing copper, as the aim of the further treatment or part of the further treatment. In these applications mentioned, a presorting step is useful in order to reduce the quantity or the mass of the material stream that is to be subsequently individualized and analyzed, the presorting allowing objects that are likely or certain to be non-recoverable to be sorted out.

The presorting step can either be integrated into the remaining method, for example into the feeding step prior to individualization, or it is also possible and advantageous to carry out the presorting step spatially and temporally separated, in particular spatially outsourced and/or temporally upstream of the other method steps. This means that, if necessary, presorting can also be carried out on a different machine and/or at a different time.

According to an advantageous variant of the presorting step, it may be provided for an optical analysis of the objects to be carried out in this step. For example, imaging or camera systems can be employed for this optical analysis, which, for example, operate in the visible spectrum or adjacent spectral ranges of the electromagnetic spectrum to analyze the objects of the bulk material and to carry out sorting in the presorting step on the basis of the analysis. The optical analysis can preferably detect and/or analyze multiple objects at the same time. In other words, this means that the optical analysis can preferably take place after the individualization of the objects, optical images of multiple objects of the bulk material preferably being generated simultaneously and the images of the objects being optically analyzed or evaluated; after the analysis or the evaluation of the optical image, parts that are to be sorted out, in particular parts that have been identified as reject parts or non-recoverable parts, are removed from the bulk material, for example from a mass flow of a bulk material, preferably blown out by means of compressed air.

According to a another, particularly advantageous embodiment of the method, the optical analysis can comprise a shape detection and/or a color detection. According to this embodiment, the imaging system of the optical analysis can also be used to take images of the objects, in which case the evaluation or analysis of the images can consist of the, if possible fully automatic, recognition of certain shapes and/or colors. For example, technical parts such as pieces of wire, nails, screws or washers can be recognized by their shape. Coins, for example, but not exclusively round, hexagonal or dodecagonal coins, can also be recognized by their shape. Pertinent methods, in particular software procedures for the automatic recognition of predefined shapes, are known in the state of the art from various fields. Preferably, but by no means necessarily, such methods can be based on artificial intelligence or neural networks in order to continuously improve the shape detection.

For color detection, a spectral analysis of the respective recorded images of the objects can be carried out, for example. Accordingly, for color detection in the visible spectrum of the electromagnetic spectrum, it is particularly advantageous to provide an imaging or camera system that also images the objects at least in the visible range. For other optical analyses, however, an imaging system that also works in the infrared range or in the UV range, for example, and generates corresponding images in these spectral ranges and makes them available for evaluation or analysis can also be advantageous.

According to another, equally advantageous variation of the method, the bulk material can be fractionated by size in the presorting step, and at least one size fraction, in particular a finest fraction, is not fed to the analyzing system. The finest fraction can contain parts or individual parts that have a dimension of up to 4 mm, preferably less than 2 mm, in at least one spatial direction, for example. The fractionation by size can be carried out in a stationary manner, without the objects being transported toward the analyzing system. However, the fractionation by size can advantageously also be carried out or take place during transport of the objects, for example in the course of the feeding step, particularly preferably prior to the individualization of the objects. Alternatively or in addition to a finest fraction, the fractionation by size can particularly preferably also include a separation of large parts, in particular long parts. The coarse-grain fraction produced in this manner can, for example, contain parts or individual parts that have a dimension greater than 35 mm in at least one spatial direction. In a particularly preferred manner, the finest fraction can be directly or immediately subjected to smelting, without first determining the material composition and carrying out further treatment.

A possibly created size fraction with particularly large parts and/or long parts can be sorted out particularly advantageously and accordingly not, or at least initially, fed to the analyzing system. However, the large and/or long parts can advantageously be fed in such a manner that the other parts of the device and steps of the method are not negatively affected. For example, a separate feeding device may be provided for the large or long parts, which feeds the parts directly to the analyzing system or the analyzing step. Alternatively, said feeding can also take place by manually feeding such parts.

For carrying out the presorting step, it may be advantageous to blow out parts or individual parts to be sorted out by means of compressed-air nozzles and/or compressed-air blasts, or to eject them using pushers or plungers.

In another, particularly preferred variation of the method, the weight or the mass of individualized objects of the bulk material can be determined in a weighing step, the weighing step preferably being carried out after the individualization of the objects in the feeding step. This embodiment of the method is of particular importance if the further treatment of the objects also concerns or includes the determination of the recoverability of the objects, preferably for the entire bulk material or an non-specifically created sample of the bulk material. This is because not only the knowledge of the material composition of the individual objects but also the associated mass or the associated weight of the respective objects is also of essential importance for determining the value or the recoverability in this case.

In principle, however, the weighing step can also facilitate and/or influence and improve the further treatment of the objects and/or serve as a control criterion, preferably after the individualization of the objects in the feeding step, in further treatments of a different nature. For example, the weighing step could carried out as a plausibility check of the determined material composition. In this case, a result of an optical analysis of the objects may also be taken into account in order to estimate whether the determined alloy composition or alloy appears plausible given the optically determined shape or the optically determined volume and the measured mass or the measured weight.

Alternatively or additionally, the weighing can also be carried out differentially, for example by monitoring and/or measuring the total weight and its change in a collecting or storage container for objects that have undergone the method, a path-time correlation between the time of analysis of the object and the change in the weight of the container and its contents allowing the individual weight of each analyzed object to be deduced. This facilitates the structural implementation of the weighing since the objects cannot be measured during a transport, but only after a transport has been completed, possibly using a conventional scale.

According to another, particularly advantageous embodiment of the method, a bulk material property can be calculated and/or extrapolated in the further treatment step, the material composition of the individual objects determined in the evaluating step preferably being linked with the determined weight or the determined mass of the respective objects during the calculation. As outlined above, a particularly advantageous further treatment can also consist in determining the value of the bulk material or of a non-specifically produced sample of the bulk material. In this case, the method according to the invention can be used in a particularly effective manner to very precisely determine the value of the analyzed bulk material or of a sample of a larger quantity of a bulk material, in which the mass or the weight is determined for each individual object examined by the analyzing system for its composition, in particular for its material composition, so that a single value can be determined for each individual object in the further treatment step, for example on the basis of raw material prices including deductions for any subsequent treatment, in particular concentration, that may still be necessary and on the basis of the determined weight or the determined mass of an object including the relative composition based on the knowledge of the material composition.

In this manner, overall, a value of the analyzed sample can be provided exactly as the sum of the individual values, and/or a value of the entire bulk material that has not been analyzed in total can be provided as an extrapolation based on the total size of the bulk material and the proportional size of the sample as part of the further treatment step. According to an advantageous variation, the calculation of the bulk material property, preferably the bulk material value, on the basis of the value of individual objects represents the entire further treatment in the further treatment step. However, in addition to determining the property of the bulk material by calculating properties of the individualized objects, additional further treatments can also be carried out or undertaken in the further treatment step. For example, the objects can also be fractionated on the basis of the determined alloys or alloy compositions as part of the further treatment step in order to check the plausibility or to visually demonstrate the determined and/or calculated property of the bulk material.

According to another particularly advantageous embodiment in this context, the fed and/or analyzed bulk material is obtained as a sample from a larger amount of material. In the case of such a sample, it can be assumed with relatively little residual uncertainty that the average composition of the sample essentially corresponds to the average composition of the entire bulk material or the entire amount of material.

As mentioned at the beginning, the limited material or quantity throughput of the present method can be largely compensated for, the very precise and accurate knowledge of the composition of the sample allowing a significantly better and more accurate prediction of the total amount, in particular of the recoverability of the total amount, when extrapolating the determined composition of the individual objects to the total amount or the entire bulk material in the course of the further treatment step than if the total amount or a significantly larger sample of the total amount of the bulk material is examined for its value using a less precise method or is even merely estimated without any examination. However, as mentioned above, it is of fundamental and great interest to have the most accurate knowledge possible of the composition of a bulk material composed of essentially metallic objects since it can be deduced from this whether further processing with the aim of recovering raw materials is economically viable and possible.

According to another, particularly preferred embodiment, bulk material, in particular a sample, having a weight of at least 500 kg can be fed in the feeding step. This amount of bulk material can be analyzed using the method according to the invention in a still acceptable period of time, for example overnight or within six to ten hours while simultaneously being an amount sufficient to be considered representative of a significantly larger quantity of bulk material, for example bulk material weighing up to 20 t.

According to another advantageous embodiment of the method, objects can be sorted into at least three fractions in the further treatment step on the basis of the material composition of the individual objects determined in the evaluating step. Advantageously, significantly more than three fractions, in particular any number of fractions, can be carried out on the basis of the determined alloys or alloy compositions of the individual objects. This is a particular advantage of the method according to the invention. Because after the material composition has been detected and/or determined in the analyzing step and in the evaluating step and, in addition, the individual objects have already been individualized in the feeding step, a basically unlimited number of fractions can be produced in the follow-up to the analyzing step, in particular with regard to the material flow.

Advantageously, at least the heavy metals copper (Cu), zinc (Zn), tin (Sn), nickel-containing metals and lead (Pb) are fractioned into one or more fractions. Aluminum (Al) can be ejected by separating all other fractions and leaving aluminum behind.

For example, fractionation can be achieved by means of compressed-air-operated ejection or blow-out devices or by means of mechanically operated pusher devices, the number of fractions being limited only by the number of ejection devices. If the ejections devices are disposed, for example, along a transport device that transports the individualized objects further after the analyzing step, an individual object can be discharged safely and reliably at a desired point, with only few limitations regarding the length of the transport device.

This achieves a particularly large increase in efficiency of the method according to the invention compared to common or known methods, which only allow a separation into two fractions per cycle or per shot, because such methods require a correspondingly large number of cycles or shots to produce or sort out a correspondingly large number of fractions. Thus, the individualization and the single-file arrangement of the individual objects, and their individual analysis and evaluation in the subsequent process, in particular in the further treatment step, can surprisingly compensate or even overcompensate for the limited quantity or part throughput compared to other methods.

According to an advantageous embodiment, for example, different recognizable or recognized metals, preferably precious metals and/or a heavy metal fraction, can be sorted in the course of the further treatment step. Advantageously, for example, each fraction can be assigned a position and an ejection or discharge device, for example a compressed-air-operated nozzle arrangement, along a transport device; on the basis of the material composition determined in the evaluating step and correlated via the transport speed of the transport device, the ejection or blow-out device is activated at the time and the object in question is discharged from the transport device when it has reached a certain position of the fraction or the discharge point of said fraction along the transport device. In the case of objects with a material composition that could be assigned to different fractions, the exact knowledge of the composition of the evaluating step can preferably be used again to make an assignment that is as accurate as possible, for example on the basis of the relative or quantitative proportion of the substances or metals to be fractionated in each case, so that the fractions produced already contain a very high concentration of the raw material to be fractionated and thus little effort is required for further use, in particular recovery of the pure raw materials, or the expenditures and investments for the recovery of the resources or raw materials, which are usually calculated per mass or per quantity, are comparatively low due to the high concentration.

According to another, particularly advantageous variation of the method, sorted fractions are subjected to smelting in the further treatment step. In this case, it is again particularly advantageous if the individual types of objects are already sorted into different fractions, which is possible in a particularly easy and effective manner in the method according to the invention due to the individualization and the exact knowledge of the composition of the individual objects.

According to another, particularly advantageous embodiment of the method, the bulk material is obtained from the residues of thermal waste treatment, in particular waste incineration. In thermal waste treatment, the residue that is generated is essentially slag, which in turn contains metal components. For example, a metal concentrate can be generated from the waste incineration slag in a selection or sorting process upstream of the method, and the metal concentrate can then be fed to the method according to the invention. In such a method, it can be particularly advantageous if non-valuable or non-recoverable objects are already sorted or sorted out in the feeding step or prior to the feeding step.

Since the metallic residues of thermal waste treatment also include a relatively large number of coins, the monetary value of which is greater than the material value of the metals of the coins, the method can additionally or exclusively be used to process coins and in particular sort them. This coin sorting can preferably also be done in addition to other metal fractionation, for example precious-metal fractionation in the further treatment step as an individual fractionation. Here, the advantage already mentioned above is useful again, namely that the further treatment can be based on an exact knowledge of each individual object and, due to the anyway existing individualization of the parts, an almost infinite number of individual fractions can be easily sorted or generated in the further treatment.

In a particularly preferred manner, individual coin types, in particular coins with a maximum relative frequency, can be sorted out as individual fractions. Alternatively or additionally, the coins can advantageously be sorted into individual fractions or discharged according to their origin. This is made possible by the fact that individual types of coins have an essentially individual composition, which can be determined in the analyzing step and in the evaluating step and matched by comparison with corresponding databases, which means that the method according to the invention makes it possible in a particularly advantageous manner that, in addition to other fractions, if applicable, fractions that not only constitute a coin concentrate but already enable pre-sorting of the coins according to type/category and/or origin are produced in the further treatment step.

In such a variation, information about the individual objects from an optical analysis, in particular in the visible range, can particularly advantageously influence or be a triggering factor for the further treatment in the further treatment step. In this case, the optical analysis can preferably be carried out after the individualization of the objects.

In another advantageous variation of the method, the bulk material can be obtained from the reclamation of motor vehicles. In this case, too, coins can advantageously be sorted out and concentrated in addition to or as an alternative to heavy metal fractions and/or precious metal fractions, as described above.

In another advantageous variation of the method, the bulk material can be obtained from the reclamation of dental waste. This dental waste, sometimes also referred to as dental scrap, can also be processed particularly effectively using the method according to the invention because, in the analyzing step, metallic portions or metallic components below a surface of an object are also determined and their composition is tested and/or evaluated. This is because dental scrap sometimes contains many objects with metallic inlays or metallic fillings, which would not be recognized as containing metal or precious metal or as recoverable in a superficial, in particular optical, analysis, for example.

The object mentioned above is also attained by means of a device for treating bulk material composed of predominantly metallic objects, the device comprising an individualization device that produces an individualization of the objects on or along a feeding device so that a minimum distance between the objects is maintained, which, at a given feeding speed of the feeding device, corresponds to a time interval required by an analyzing system to analyze an object, the device further comprising such an analyzing system for performing an X-ray fluorescence analysis or a laser-induced plasma spectroscopy, and the device further comprising evaluation means for determining the material composition of the individual objects on the basis of the information about the objects obtained in the analyzing step, and the device further comprising further treatment means with which the individual objects are treated further on the basis of the determined material composition.

According to the invention, the analyzing system is configured in such a manner that in the course of the X-ray fluorescence analysis (XRF analysis) or the laser-induced plasma spectroscopy (LIPS), the individual parts are analyzed from two essentially opposite, preferably parallel, analyzing directions so that each individual part is analyzed from two sides.

For example, the individualization can be achieved by means of a controlled mechanical hurdle that is actuated by a light barrier or another type of control mechanism. Other individualization devices may also be used.

### BRIEF DESCRIPTION OF THE DRAWINGS

Hereinafter, the invention will be explained with reference to the drawings, which are merely schematic in nature and serve as examples of possible embodiments.

FIG. 1: is a flow diagram of a first embodiment of a method according to the invention;

FIG. 2: is a flow diagram of a second embodiment of a method according to the invention;

FIG. 3: is a schematic illustration of a device according to the invention for implementing a third embodiment of the method according to the invention;

FIG. 4a: is a schematic illustration of an analyzing step of four rows of objects disposed one behind the other;

FIG. 4b: is a schematic illustration of an analyzing step of four rows of objects disposed one behind the other from two essentially opposite directions.

### DETAILED DESCRIPTION

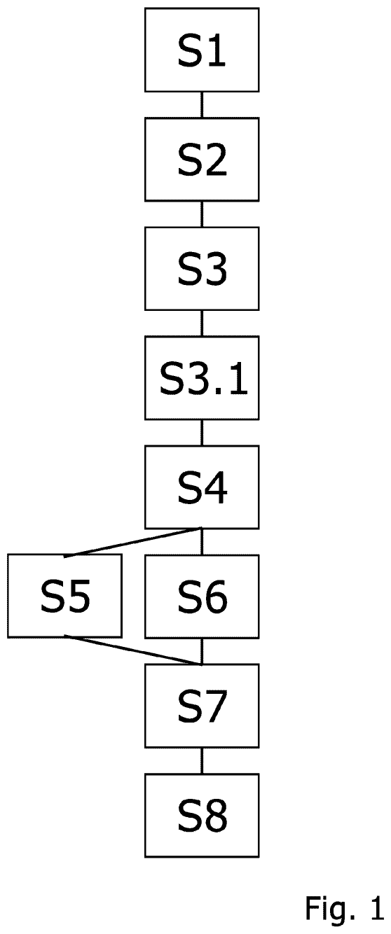

FIG. 1 shows a flow diagram of a method with a first providing step S1. In this providing step, a bulk material can be provided or supplied. In the method of the embodiment of FIG. 1, the objective of the method according to the invention is to determine the value or recoverability of the bulk material itself or at least to predict it with a high degree of accuracy and/or reliability, this prediction, determination and/or calculation essentially taking place in a further treatment step, which will be described below.

In order to counterbalance or compensate for the limitation of the quantity or mass throughput by the individualization of the individual objects and analysis of the individual objects, a sample is taken from the bulk material in a second method step, which is a sampling step S2.

Method steps S1 and S2 can be carried out individually and/or in combination either immediately prior to the subsequent method steps or at a significant time interval after the subsequent method steps. For example, a created sample or specimen can easily be stored for multiple hours, days or even weeks without this having any influence, in particular a negative influence, on the subsequent method steps of the method according to the invention.

It is also possible to spatially separate steps S1 and S2 from other steps of the method.

In the subsequent feeding step S3, the objects of the bulk material can basically be moved toward or in the direction of an analyzing system. This can be done by suitable transport devices, such as transport belts, conveyor belts or vibratory chutes. In this feeding step S3, an individualizing step S3.1 can be carried out as a further method step, the individualizing step S3.1 leading to an individualization of an essentially one-dimensional single-file arrangement of individual parts, the individual parts having a minimum distance from each other, which, at a given feeding speed, corresponds to a time interval that is required by an analyzing system to analyze an individual object.

In a subsequent method step, which follows the feeding step S3 and the individualization in the individualizing step S3.1 carried out in the course of the feeding step S3, an analyzing step S4 is carried out, in which the individually fed objects are analyzed by means of X-ray fluorescence analysis or laser-induced plasma spectroscopy. The data obtained in the analyzing step concerning the material composition can be stored or temporarily stored in data processing systems. The analyzing step S4 can comprise a twofold analysis of an individual part from two essentially opposite directions in order to be able to determine the material composition as well and as reliably as possible even for inhomogeneous individual parts.

In a particularly advantageous case, the analyzing step S4 can be followed by the evaluating step S5. In the evaluating step S5, the material composition of the individual objects analyzed with the analyzing system in the analyzing step is determined or identified. The stored or temporarily stored data from the analyzing step S4 can be used for this.

The evaluating step S5 can be carried out in parallel with other steps and in particular independently of the material flow after the analyzing step S4, as illustrated in the flow diagram. Accordingly, a weighing step S6 can, for example, be carried out in parallel with the evaluating step S5 in the course of a further transport of the analyzed and individualized objects or parts, in which the individual parts are weighed or the mass of the individual parts is determined. However, it may also be provided for the weighing step S6 to not take place after the analyzing step S4 and/or in parallel with the evaluating step S5 but in the course of the feeding step S3, particularly preferably following the individualizing step S3.1 and prior to the analyzing step S4, while the already individualized objects are being conveyed or fed to the analyzing system. Alternatively or additionally, a differential weighing of the individual objects can take place by means of a continuous weighing at the end of the method in a collecting or storage container, in which case the time difference between the analysis of the object and the arrival in the container must then be taken into account.

Another method step S7 constitutes the further treatment step. In this further treatment step, the determined material composition of the individual objects as the result of the evaluating step S5 is used as the basis for the further treatment. In the example or in the embodiment of FIG. 1, the weight or mass of the individual objects according to weighing step S6 can also be used in the further treatment in addition to the determined material composition of the individual objects according to evaluating step S5, and a bulk material property can be calculated in the further treatment step S7. In particular, the calculation is carried out by linking the determined material composition with the determined weight or the determined mass of the respective objects. Thus, a value is determined as a bulk material property.

Based thereon, the value of the total amount of bulk material provided in method step S1 can be extrapolated in a final method step, which is carried out, for example, as a value assessment step S8, so that, as a result of the method and in particular as a result of the value assessment step S8, a decision can be made as to whether and which further steps and methods can or must be carried out in order to be able to carry out further treatment for the recovery of raw materials in an economically efficient manner.

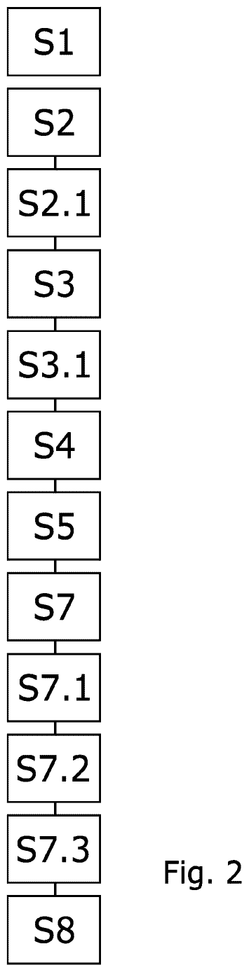

FIG. 2 shows a flow diagram of a second embodiment of the method according to the invention. The providing step S1 can still proceed analogously to the embodiment of the method according to FIG. 1. In the subsequent method step, however, a presorting step S2.1 can be carried out, in which case, as a result of the presorting step S2.1, part of the bulk material is not fed to the individualizing step S3.1 of the feeding step S3 but is already sorted out beforehand. The presorting step can be carried out prior to the feeding step or during the feeding step.

In principle, presorting can also be carried out after the individualizing step S3.1. However, this then unnecessarily increases the distances between the individual parts or objects disposed one after the other. It is therefore particularly advantageous if presorting steps are carried out prior to the individualizing step S3.1 and prior to or during the feeding step S3. The presorting step can be carried out, for example, on the basis of an optical analysis, in particular on the basis of a color detection and/or on the basis of a shape detection. Alternatively or additionally, a fractionation by size can be carried out in a presorting step, in which at least one size fraction, preferably a finest fraction, is not fed to the analyzing step but is instead is sorted out prior to the analyzing step S4, in particular prior to the individualizing step S3.1, and optionally subjected to smelting.

Advantageously, various different presorting steps can be carried out. In this case, individual presorting steps S2.1 can be integrated directly into the material flow of the feeding step S3 or can be carried out or undertaken at a different time and in a different place from the feeding step S3.

With regard to the feeding step S3 and the individualizing step S3.1, reference can essentially be made to the embodiment of FIG. 1. The same applies to the evaluating step S5. In the embodiment of FIG. 2, a weighing step S6 is to be dispensed with. However, this step can be provided in addition to the method steps shown in FIG. 2 in another variation.

The further treatment step S7 of the method according to FIG. 2 comprises at least three sub-steps or partial steps in the described variation, namely three sorting steps or fractionating steps S7.1, S7.2 and S7.3. In the illustration of FIG. 2, the manner in which the fractionating steps S7.1, S7.2 and S7. 3 are shown illustrates that the respective fractionations take place one after the other, for example as an ejection from a material stream after the analyzing step S4. This is a particular advantage of the method according to the invention, especially since any number of fractionating steps can be arranged one after the other or carried out one after the other. It is therefore useful to know the position of the respective individualized objects with sufficient tolerance in order to be able to effect the appropriate ejection or fractionation assignment at the right moment or in the right position. This can be achieved, for example, by measuring the run time in conjunction with a known transport speed after the analyzing step S4.

Subsequent to the evaluating step S5, knowing the material composition of the individual parts or individual objects of the bulk material, with a corresponding specification or definition of further treatment criteria, in particular fractionating criteria, basically any large number of fractionating steps, in particular preferably at least three fractionating steps, can be carried out. Particularly advantageously, in addition to the alloy properties determined in the evaluating step S5, other knowledge that has been determined or gained, for example, during the feeding step S3, in particular after the individualizing step S3.1, can also be taken into account. For example, color information and/or shape information and, as already mentioned, possibly also weight or mass information can be used to make the further treatment step S7, in particular the fractionating steps S7.1, S7.2 and S7.3, as effective as possible. In the fractionating steps, one or more different precious-metal fractions can be obtained, for example. Coins can also be sorted by type and/or value and/or origin.

The individual metal fractions can particularly preferably be subjected to smelting in a smelting step S9.

In the method of FIG. 2, it can also be advantageous to first carry out the analyzing step S4 and then, in a subsequent method step, to obtain or generate additional color and/or shape information using corresponding measuring systems. This is because the color information and/or the shape information of individual or individualized objects can be determined in this case, which can provide added value in the subsequent fractionation.

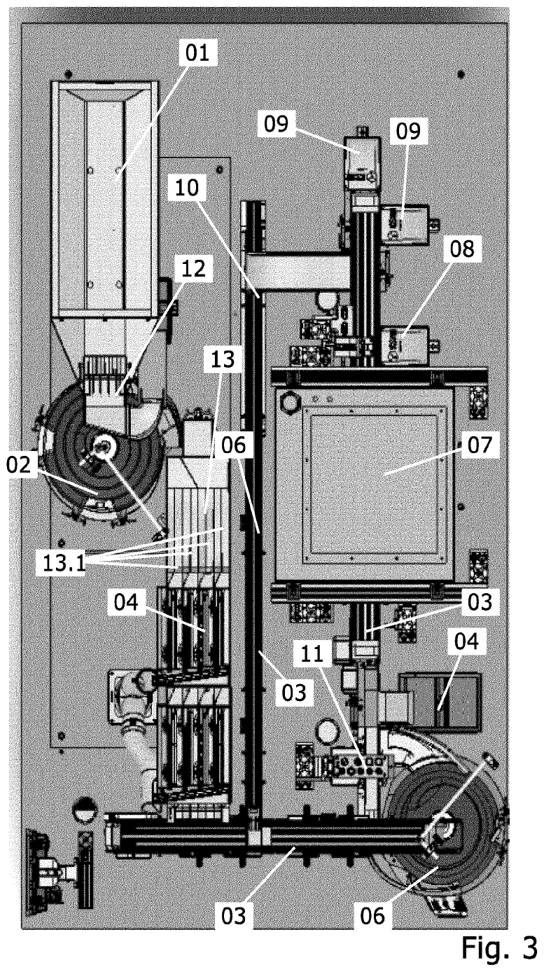

FIG. 3 shows an example of a system layout in which the bulk material is obtained from the reclamation of dental waste or from the ashes of crematoria. This bulk material is initially provided as source material in a storage vessel 01, which is a bunker. A first conveying and individualizing device 02 is used to transfer the bulk material from the storage vessel 01 to a feeding step, in which a specific sample is also produced by presorting in the variation of FIG. 3. Before the objects pass through the conveying and individualizing device 02, a long-part separator 12, for example, can be used to separate long parts. The objects then pass through a distribution device 13, which also serves for individualization, among other things. The distribution device also distributes the objects onto different tracks 13.1 of a presorting device 05, which is a separating section with mechanical separating or sorting means, for example, so that an initial fractionation by size is carried out. In the example of FIG. 3, the presorting device 05 can have two stages 14 and thus effect a separation of small parts. Preferably, a fractionation into objects of <2 mm and >2 mm can be carried out.

After that, at least one size fraction passes via a transport device 03 to an individualization device 06, which enables the objects to be arranged one behind the other. A inspection device 11 can be arranged downstream thereof. For example, the inspection device can check the distance between the objects and, if the distance falls below a minimum distance, can ensure that objects that are too close together are fed back into the individualization device 06. Furthermore, the inspection device 11 can be connected or linked to the analyzing system 07 and/or the imaging system 08 in such a manner that the inspection device 11 makes objects identifiable in terms of time and/or position, for example by means of an identifier or an identification number, so that, based on the path or time offset, the information obtained by these systems 07, 08 about the objects can be assigned to them and that a selective further treatment, in particular sorting/fractioning, can then take place.

The inspection device 11 can also be used to effect a further pre-sorting of the objects with regard to their thickness. Objects that do not exceed a predetermined thickness, for example >25 mm or >29 mm, can be sorted out into the discharge vessel 04 by the inspection device 11 via the one discharge mechanism during their onward transport along the transport device 03. The transport device 03 can transport the remaining objects to the analyzing system 07, which analyzes the objects individually and one after the other.

After the analysis by the analyzing system, an optical analysis can also be carried out using an imaging system 08, which generates images of the individual parts and evaluates them with an evaluation system (not shown). On the basis of the analysis of the analyzing system 07 and the imaging system 08 and the evaluation of the analysis in the evaluating step, a further treatment of the individual objects or parts can be carried out downstream of the analyzing system 07 and the imaging system, the result of the evaluating step being made the basis of the further treatment. For example, precious metals can be discharged in a discharge unit 04 or a fractionation device. In a return device 10, white metal or unrecognized objects can be returned, and non-precious metals can be collected or concentrated in another fractionation device 09. A third fractionating step or a third fractionating unit (not shown) can collect or discharge non-recoverable residual parts, for example.

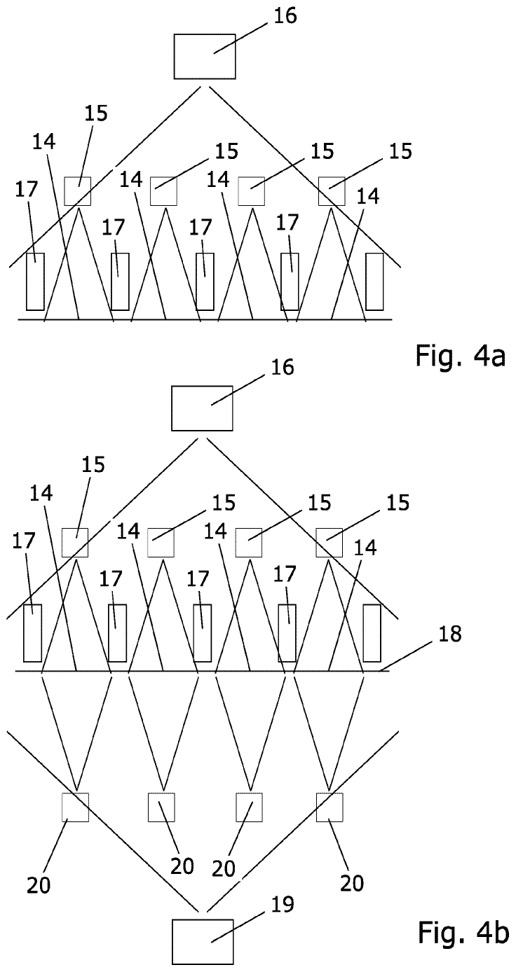

FIG. 4a shows a schematic illustration in which, for example, 4 lines or rows 14 of single-file arrangements of objects are analyzed in parallel. The four rows 14 can, for example, be generated in the individualization process or individualizing step, taking care that the objects in the individual rows 14 do not fall below a minimum distance. A measuring probe 15, which carries out the analysis of the objects, is assigned to each row 14. Particularly preferably, a common excitation or radiation source 16, such as an X-ray source, can be used to generate the analysis radiation, the interaction of which with the objects in the rows 14 can be detected and processed by the respective measuring probe 15. The rows 14 can be separated by dividers 17, which ensure spatial and/or radiation-related separation. By analyzing four or more rows of objects, the throughput of the method can be increased many times over.

FIG. 4b shows a modified embodiment in which, in addition to the radiation source 16, another radiation source 19 is disposed on the opposite side of a transport device 18 for the parts or individual parts (not shown), the other radiation source 19 irradiating the individual parts through a transport device 18 that is transparent to the analysis radiation of radiation source 19. Likewise, measuring probes 20 associated with radiation source 19 are provided, which analyze the parts from a direction that is essentially opposite to the analyzing direction of the measuring probes 15. This allows the material composition even of inhomogeneous parts to be optimally determined. The radiation sources 16 and 18 the associated measuring probes 15 and 20, respectively, can be disposed one behind the other or at different positions in a transport direction, perpendicular to the drawing plane. The two-sided analysis is not limited to embodiments with multiple rows 14 of single-file arrangements of objects. A corresponding two-sided, oppositely directed analysis can also take place or be carried out advantageously in the case of an singular single-file arrangement.

As an alternative to a transparent transport device 18, the two-sided irradiation and analysis can also be realized in combination with a fall section, on which the parts to be analyzed are in free fall. In this case, the drawing plane of FIG. 4b would be essentially perpendicular to a weight force vector.

Alternatively, the parts can also be turned, preferably by 180°, after they have passed through an analyzing system, for example according to FIG. 4a, in the course of a constrained guidance and then pass through an analyzing system again, for example according to FIG. 4a, or be returned to the original analyzing system and analyzed again in the turned state.

### REFERENCE SIGNS

01 storage vessel
02 individualization device
03 transport device
04 first discharge vessel
05 presorting device
06 individualization device
07 analyzing system
08 imaging system
09 fractionation device
10 return device
11 inspection device
12 long-parts separator
13 distribution device
13. tracks
14 rows
15 measuring probe
16 excitation or radiation source
17 divider
18 transparent transport device
19 radiation source
20 measuring probe
S1 providing step
S2 sampling step
S2.1 presorting step
S3 feeding step
S3.1 individualizing step
S4 analyzing step
S5 evaluating step
S6 weighing step
S7 further treatment step
S7.1 fractionating step
S7.2 fractionating step
S7.3 fractionating step
S8 value assessment step
S9 smelting step

1. A method for treating bulk material composed of predominantly metallic objects, the method comprising the following step:
individualizing objects in a feeding step (S3), the individualizing leading to an essentially one-dimensional single-file arrangement of individual parts, the individual parts having a minimum distance from each other, which, at a given feeding speed, corresponds to a time interval required by an analyzing system to analyze an object;
carrying out an X-ray fluorescence analysis (XRF analysis) or a laser-induced plasma spectroscopy (LIPS) of individual objects provided by the feeding step by means of an analyzing system in an analyzing step (S4);
determining the material composition of the individual objects of the analyzing step in an evaluating step (S5);
carrying out a further treatment step (S7), in which the determined material composition of the individual objects serves as a basis for further treatment, wherein
in the course of the X-ray fluorescence analysis (XRF analysis) or the laser-induced plasma spectroscopy (LIPS) by means of an analyzing system, the individual parts are analyzed from two essentially opposite, analyzing directions so that each individual part is analyzed from two sides.

2. The method according to claim 1, further comprising
a presorting step (S2.1) prior to the analyzing step (S4), in which part of the bulk material is sorted out and not fed to the analyzing system.

3. The method according to claim 2, wherein
in the presorting step (S2.1), the objects are optically analyzed.

4. The method according to claim 3, wherein
a shape detection and/or a color detection is carried out in the optical analysis.

5. The method according to claim 2,
wherein
in the presorting step (S2.1), the bulk material is fractionated by size, and at least one size fraction is not fed to the analyzing system.

6. The method according to claims 1
further comprising
a weighing step (S6), in which the weight or the mass of individual objects of the bulk material is determined, the weighing step being carried out after the individualization of the objects in the feeding step (S3) and/or at the end of the method as a differential measurement in a collecting vessel.

7. The method according to claim 1,
wherein
in the further treatment step (S7), a bulk material property is calculated, the calculation involving linking the material composition of the individual objects determined in the evaluating step (S5) with the determined weight or the determined mass of the object in question.

8. The method according to claim 1,
wherein
the bulk material is obtained as a sample from a larger amount of material.

9. The method according to claim 8,
wherein
in the feeding step, bulk material with a weight of at least 500 kg is fed.

10. The method according to claim 1,
wherein
in the further treatment step (S7), objects are sorted into at least three fractions based on the material composition of the individual objects determined in the evaluating step (S5).

11. The method according to claims 1 ,
characterized in that wherein
in the further treatment step (S7), different fractions of detectable/detected metals are sorted.

12. The method according to claim 11,
wherein
in the further treatment step (S7), different precious-metal fractions are sorted.

13. The method according to claim 11,
characterized in that wherein
in the further treatment step (S7), different heavy-metal fractions are sorted.

14. The method according to claim 10,
wherein
in the further treatment step (S7), sorted fractions are subjected to smelting.

15. The method according to claim 1,
characterized in that wherein
in the course of the individualization of the objects, a plurality of single-file arrangements with a minimum distance between the objects in each single-file arrangement are produced, the single-file arrangements running or being oriented parallel to each other.

16. The method according to claim 1,
wherein
the bulk material is obtained from the residue of thermal waste treatment.

17. The method according to claim 1,
wherein
the bulk material is obtained from the reclamation of motor vehicles.

18. The method according to claim 1,
wherein
the bulk material is obtained from the reclamation of dental waste or from the ash of crematories.

19. A device for treating bulk material composed of predominantly metallic objects, the device comprising an individualization device that produces an individualization of the objects on or along a feeding device so that a minimum distance between the objects is maintained, which, at a given feeding speed of the feeding device, corresponds to a time interval required by an analyzing system to analyze an object, the device further comprising such an analyzing system for performing an X-ray fluorescence analysis or a laser-induced plasma spectroscopy, and the device further comprising evaluation means for determining the material composition of the individual objects on the basis of the information about the objects obtained in the analyzing step, and the device further comprising further treatment means with which the individual objects are treated further on the basis of the determined material composition,
wherein
the analyzing system is configured in such a manner that in the course of the X-ray fluorescence analysis (XRF analysis) or the laser-induced plasma spectroscopy (LIPS), the individual parts are analyzed from two essentially opposite analyzing directions so that each individual part is analyzed from two sides.

20. The method according to claim 1, wherein the two essentially opposite analyzing directions are parallel.
